(19) United States
(12) Patent Application Publication
(10) Pub. No.: US 2025/0045349 A1
(43) Pub. Date: Feb. 6, 2025

(54) LINEAR MEMORY ATTENTION SYSTEM AND METHODS

(71) Applicant: Google LLC, Mountain View, CA (US)

(72) Inventors: Markus Norman Rabe, San Francisco, CA (US); Charles Edgar Staats, III, Mountain View, CA (US)

(21) Appl. No.: 18/715,449

(22) PCT Filed: Dec. 2, 2022
(86) PCT No.: PCT/US2022/051725

§ 371 Date: May 31, 2024

Related U.S. Application Data
(60) Provisional application No. 63/285,423, filed on Dec. 2, 2021.

(51) Int. Cl. G06F 17/16

(52) U.S. Cl. CPC G06F 17/16

(57) ABSTRACT

A linear memory attention system and method implements an iterative process to compute attention by first computing partial first and partial second attention components for a token for each iteration. From these partial first and partial second attention components for each iteration, respective first and second attention components are then determined. On the final iteration for the token, attention for the token is computed by dividing the second attention component by the first attention component. In an implementation, a normalization scaler is used to ensure numerical stability. In an implementation, parallelism is achieved by splitting queries into chunks of constant size and processing the keys and values of the chunks. The use of checkpointing facilitates a more efficient use of memory and allows for recomputation during backpropagation.

### CROSS-REFERENCE TO RELATED APPLICATIONS

This is application claims the benefit under 35 U.S.C. § 119 (e) of U.S. Application No. 63/285,423, filed on Dec. 2, 2021, the contents of which are hereby incorporated by reference. The disclosure of the foregoing application is incorporated herein by reference in its entirety.

### BACKGROUND

This specification relates to systems and methods for determining attention.

Attention is widely used in neural architectures, and in transformers in particular. The result of current attention operations for a single query is a weighted sum of value vectors, where the weights are the softmax of the dot products of a query and a keys. Transformers use self-attention, which issues a separate query for each position in token sequence. This results in an overall time and space (memory) complexity of O(n²).

In modern accelerator hardware, such as GPUs and TPUs, memory is often constrained for applications in deep learning. Thus, the space complexity of transformers can present challenges when implemented using such accelerator hardware.

### DETAILED DESCRIPTION

This specification generally describes systems and methods for determining attention in a manner that reduces memory requirements when compared to current attention systems. Consequently, the methods described herein may allow attention-based neural networks to be executed on systems with a constrained memory space.

In one aspect, a method includes receiving a set of n tokens arranged in respective ordinal positions: for at least one of the tokens: iteratively computing a first attention component for the token and a second attention component for the token based on respective ordinal positions of the n tokens, and for each iteration: computing, for a current iteration count, a partial first attention component for the token that is based on a dot product of a query vector for the token and a key vector for a token at an ordinal position in the set of tokens that correspond to the current iteration count, computing, for the current iteration count, a partial second attention component for the token that is a product of the partial first component computed for the current iteration count and a value vector for the token at the ordinal position in the set of tokens that corresponds to the current iteration count, when a partial first attention component has been computed for the token for a prior iteration count for the token, summing the partial first attention component for the current iteration count with the first attention component from the prior iteration count to obtain the first attention component for the token, when a partial second attention component has been computed for the token for a prior iteration count for the token, summing the partial second attention component for the current iteration count with the second attention component from the prior iteration count to obtain the second attention component for the token, after iteratively computing the first attention component and the second attention component for the token, computing attention for the token by dividing the second attention component by the first attention component. Other aspects includes systems and software storing instructions that cause systems to perform the operations of the above-described method.

The subject matter described in this specification can be implemented in particular embodiments so as to realize one or more of the following advantages.

In some implementations, a process for the attention operation that requires O(1) memory with respect to sequence length. This is in contrast with the O(n) memory requirement in other implementations of attention. Further, processes for the self-attention operation that requires O(\sqrt{n}) and O(log(n)) with respect to sequence length. This is in contrast with the O(n²) memory requirement in other implementations for self-attention.

Because device memory rather than compute capability is often the limiting factor on modern accelerators, reducing the memory requirements of attention allows processing of longer sequences than might otherwise be feasible. In some implementations, however, while the complexity may still approach O(n²), but a technological improvement in the context of more efficient utilization of memory is still achieved.

The process described below can save memory relative to other processes by summarizing parts of the attention matrix sequentially, allowing a system to “forget” the parts of the attention matrix it has summarized already. Applying checkpointing to a function that summarizes the individual processed chunks allows for intermediate results to be forgotten during the forward pass and recomputed during backpropagation, e.g., by running forward from the closest recorded results. This results in reduced memory complexity.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system block diagram of a linear memory attention system.

FIG. 2 is a flow diagram of an example process for determining attention.

FIG. 3 is a flow diagram of an example normalization process.

FIG. 4 is a flow diagram of an example process for implementing the system of FIG. 1 to facilitate parallel processing.

### DETAILED DESCRIPTION

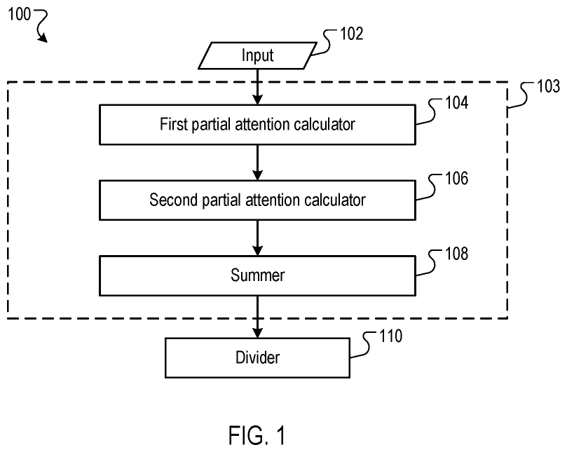

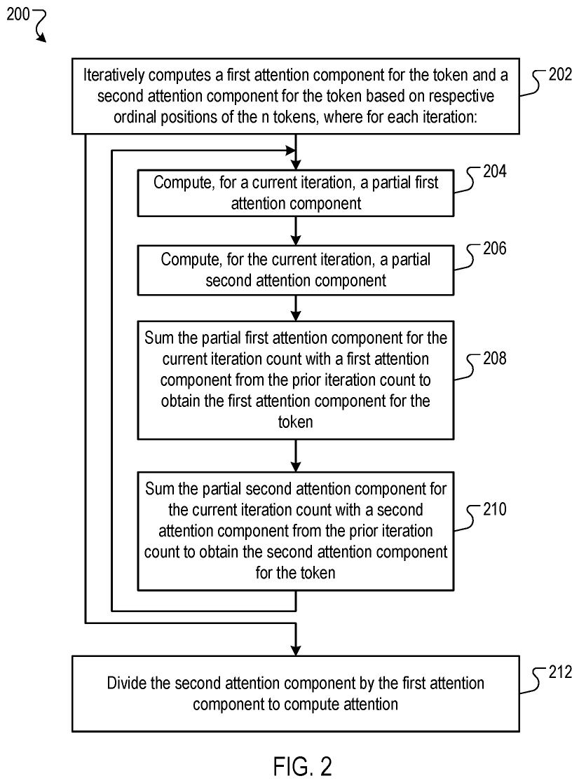

FIG. 1 is a system block diagram of a linear memory attention system 100. The system implements a linear memory attention determination process, which is further described with reference to FIG. 2. As used in this specification, the term “linear memory” in the context of attention means a system and/or process that does not scale memory requirements at O(n²), but instead scales memory requirements at a lower rate, such as O(n), or O(\sqrt{n}). The term “linear memory,” however, does not imply that time requirements scale at a lower factor.

In general, the linear memory attention system 100 implements an iterative process to compute attention by first computing partial first and partial second attention components for a token for each iteration. From these partial first and partial second attention components for each iteration, respective first and second attention components are then determined. On the final iteration for the token, attention for the token is computed by dividing the second attention component by the first attention component.

In an implementation, the system 100 computes attention for a given query q∈ [symbol] ^{d} and lists of keys k₁ . . . kₙ and values v₁ . . . vₙ∈ [symbol] ^{d} according to the following algorithm:

$${s}_{i} = dot ( q , {k}_{i} ) , \qquad ( 1 )$$

$${s}_{i}^{′} = {e}^{{s}_{i}} ,$$

$$attention ( q , k v ) = \frac{{\sum }_{i} {v}_{i} {s}_{i}^{′}}{{\sum }_{j} {s}_{j}^{′}}$$

A system implementing the algorithm (1) can do so with constant memory. The memory overhead of this algorithm is based on a vector v*∈ [symbol] ^{d} and a scaler s*∈ [symbol] ^{d}, both initialized to 0. Given the query q, keys k₁ . . . kₙ and values v₁, . . . vₙ, the system 100 processes the keys and values in sequence. For a given key value pair kᵢ, vᵢ, the system 100 computes sᵢ=dot(q, kᵢ) and updates v*←v++vᵢe^{s}^{ᵢ} and s*←s*+e^{s}^{ᵢ}. After processing all keys and values, the system then divides v* by s*. i.e., v*/s*, to obtain the attention for the token.

The value e^{s}^{ⁱ} is referred to as a partial first attention component, and is computed for each iteration. After the first iteration, the value for i=1 becomes the first attention component s*. Thereafter, for each subsequent iteration, the first attention component s*is the sum of the partial first attention component for the current iteration count with the first attention component from the prior iteration count, i.e., s*←s*+e^{s}^{ᵢ}.

Likewise, the value vᵢe^{s}^{ᵢ} is referred to as the partial second attention component. After the first iteration, the value for i=1 becomes the second attention component v*. Thereafter, for each iteration, the second attention component v*is the sum of the partial second attention component for the current iteration count with the second attention component from the prior iteration count, i.e. v*←v*+vᵢe^{s}^{ᵢ}.

For implementations in which the inputs are given in a particular order, the system 100 first reads the query, and then a list of pairs of keys and values. For implementations in which the inputs are provided in a different order, the system 100 stores an index into the sequence, requiring O(log n) memory instead.

To extend the process to self-attention, the system 100 computes the results to all queries sequentially. This requires an additional index into the list of queries, resulting in O(log n) memory complexity. The operation produces outputs that are linear in the size of the number of queries, i.e., O(n), which is not counted towards the space/memory complexity.

A particular implementation of the of algorithm (1) is described with reference to FIGS. 1 and 2. The system 100 receives an input 102. The input can be, for example, a set of n tokens arranged in respective ordinal positions. The system 100 then implements an iterative process, as indicated by phantom box 103, in which a partial first attention calculator 104 determines a partial first attention component, and a partial second attention calculator 106 determines a partial second attention component. If the iteration is the first iteration, these partial first and second attention components become the first and second attention components. On the second and subsequent iterations, however, when the partial first attention component has been computed for the token for a prior iteration count, a summer 108 sums the partial first attention component for the current iteration count with the first attention component from the prior iteration count to obtain the first attention component for the token. Likewise, when the partial second attention component has been computed for the token for a prior iteration count, the summer 108 sums the partial second attention component for the current iteration count with the second attention component from the prior iteration count to obtain the second attention component for the token.

After the iterative process is completed, the system 100 uses a divider 110 to divide the second attention component by the first attention component to obtain attention for the token.

In operation, the system 100 implements a process 200 that, for at least one token, and, optionally, for all tokens sequentially, iteratively computes a first attention component for the token and a second attention component for the token based on respective ordinal positions of the n tokens (202). The iterative process encompasses process steps 204-210.

The process computes, for a current iteration, a partial first attention component (204). The partial first attention component for the token is based on a dot product of a query vector for the token and a key vector for a token at an ordinal position in the set of tokens that correspond to the current iteration count, e.g., sᵢ=dot (q, kᵢ). Calculating the partial first attention component for the token can include exponentiating the dot product of the query vector for the token and the key vector for the token at the ordinal position in the set of tokens that corresponds to the current iteration count, e.g., s′ᵢ=e^{s}^{ᵢ}.

The process computes, for the current iteration, a partial second attention component (206). The partial second attention component for the token can be a product of the partial first component computed for the current iteration count and a value vector for the token at the ordinal position in the set of tokens that corresponds to the current iteration count, e.g., vᵢe^{s}^{ᵢ}.

During the first iteration, the partial first attention component becomes the first attention component, and the partial second attention component becomes the second attention component, e.g., s*←e^{si} and v*←vᵢe^{s}^{ᵢ}. However, during a second and subsequent iterations, when a partial first attention component has been computed for the token for a prior iteration count for the token, the process 200 sums the partial first attention component for the current iteration count with the first attention component from the prior iteration count to obtain the first attention component for the token (208). Likewise, when a partial second attention component has been computed for the token for a prior iteration count for the token, the process 200 sums the partial second attention component for the current iteration count with the second attention component from the prior iteration count to obtain the second attention component for the token (210).

After iteratively computing the first attention component and the second attention component for the token, when the iterations are completed, the process 200 computes attention for the token by dividing the second attention component by the first attention component (212).

In some implementations, when summing the partial first attention component for the current iteration count with the first attention component from the prior iteration count to obtain the first attention component for the token, the process 200 storing the first attention component for the token in a same memory location for each iteration. Likewise, when summing the partial second attention component for the current iteration count with the second attention component from the prior iteration count to obtain the second attention component for the token, the process 200 stores the second attention component for the token in a same memory location for each iteration.

For self attention, the process 200 processes each token of the n tokens in sequence. In particular, the process 200 iteratively computes the first attention component for the token and the second attention component for the token based on respective ordinal positions of the n tokens. Then, after iteratively computing the first attention component and the second attention component for the token, the process 200 computes attention for the token by dividing the second attention component by the first attention component.

In the implementations described above, each token corresponds to a portion of a sentence. More specifically, tokens can correspond to individual characters, to sub-words (e.g., “sub”-“word”-“s” for “subwords”), to entire words, or to groups of words. The tokens can be generated, for example, by using an embedding algorithm.

In some implementations, the query vector is a vector based on a query matrix of a transformer, the value vector is a vector based on a value matrix of a transformer, and the key vector is a vector based on a key matrix of a transformer. Other data constructs can also be processed using the methods described above.

Tables 1 and 2 below illustrate the calculation of attention for an input based on “I am a student.” Table 1 illustrates attention calculated for q₁, and table 2 illustrates attention calculated for q₂.

TABLE 1

| | | | | | Partial first attention | Partial second attention | |
|---|---|---|---|---|---|---|---|
| | | | | | component/first | component/second | Attention |
| Input | Q | K | V | | attention component | attention component | Score |
| I | q₁ | k₁ | v₁ | q₁*k₁ = s₁ | exp(s₁) = s′₁/ | s′₁*v₁/ | v*/s* |
| | | | | | s* = s′ | v* = s′₁*v₁ | |
| am | | k₂ | v₂ | q₁*k₂ = s₂ | exp(s₂) = s′₂/ | s′₂*v₂/ | |
| | | | | | s* = s* + s′₂ | v* = v* + s′₂*v₂ | |
| a | | k₃ | v₃ | q₁*k₃ = s₃ | exp(s₃) = s′₃/ | s′₃*v₃/ | |
| | | | | | s* = s* + s′₃ | v* = v* + s′₃*v₃ | |
| student | | k₄ | v₄ | q₁*k₄ = s₄ | exp(s₄) = s′₄/ | s′₄*v₄/ | |
| | | | | | s* = s* + s′₄ | v* = v* + s′₄*v₄ | |

TABLE 2

| | | | | | Partial first attention | Partial second attention | |
|---|---|---|---|---|---|---|---|
| | | | | | component/first | component/second | Attention |
| Input | Q | K | V | | attention component | attention component | Score |
| I | | k₁ | v₁ | q₄*k₁ = s₁ | exp(s₁) = s′₁/ | s′₁*v₁/ | |
| | | | | | s* = s′ | v* = s′₁*v₁ | |
| am | | k₂ | v₂ | q₄*k₂ = s₂ | exp(s₂) = s′₂/ | s′₂*v₂/ | |
| | | | | | s* = s* + s′₂ | v* = v* + s′₂*v₂ | |
| a | | k₃ | v₃ | q₄*k₃ = s₃ | exp(s₃) = s′₃/ | s′₃*v₃/ | |
| | | | | | s* = s* + s′₃ | v* = v* + s′₃*v₃ | |
| student | q₄ | k₄ | v₄ | q₄*k₄ = s₄ | exp(s₄) = s′₄/ | s′₄*v₄/ | v*/s* |
| | | | | | s* = s* + s′₄ | v* = v* + s′₄*v₄ | |

When using floating point arithmetic, the attention process may not be numerically stable, because the softmax exponentiates the scores. Certain scores can result in inf, which is then carried through to the final result of the attention operation. In practice in some attention mechanisms, the softmax is implemented by subtracting the maximum score from all scores. This computation is mathematically equivalent to the softmax, but avoids this numerical problem.

However, for the process of FIGS. 1 and 2, which involves incremental computation of the sum of exponentiated scores, and the values multiplied by the scores, numerical stability is not ensured by subtraction process, as the maximum may depend on the last score in the sequence. But the subtraction cannot be delayed to the last step, because the scores must be exponentiated before they can be added to the cumulative sum.

To resolve this problem, the system 100 can implement a normalization scalar, m*, that keeps track of the maximum score that the incremental process has determined, and the system 100 renormalizes the sums of exponentiated values.

In operation, the system initializes the vector v*∈ [symbol] ^{d} and the scaler s*∈ [symbol] ^{d} with 0, and m* with −inf. As before, for a given key value pair kᵢ, vᵢ, the system 100 computes sᵢ=dot(q, kᵢ). However, the system 100 then computes, for an iteration, a current normalization scaler mᵢ=max (m*, sᵢ).

Thereafter, the system 100 computes the partial first attention component, the partial second attention component, the first attention component and the second attention component based, in part, on the current normalization scaler mᵢ and the prior normalization scaler from the prior iteration, m*. The system then updates as follows:

$${v}^{*} ← {v}^{*} {e}^{{m}^{*} - {m}_{i}} + {v}_{i} {e}^{{s}_{i} - {m}_{i}}$$

$${s}^{*} ← {s}^{*} {e}^{{m}^{*} - {m}_{i}} + {e}^{{s}_{i} - {m}_{i}}$$

$${m}^{*} ← {m}_{i}$$

After processing all keys and values, the system then divides v* by s*. i.e., v*/s*, to obtain the attention for the token.

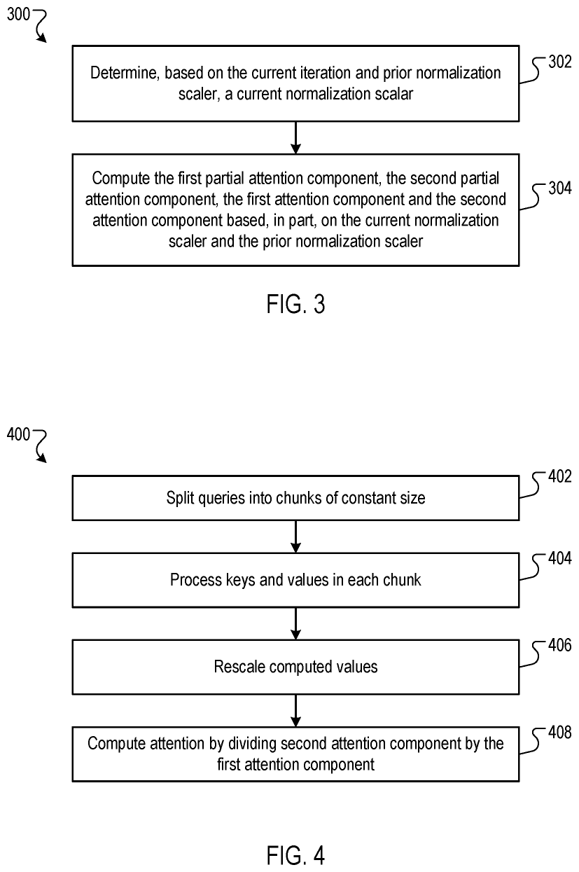

FIG. 3 is a flow diagram for an example normalization process 300. The process 300 determines, based on the current iteration and prior normalization scaler, a current normalization scalar (302). For example, for a current iteration i, the prior normalization scaler is m*, computed at the end or the last iteration (or −inf, if the iteration is the first iteration), and the current normalization scaler is mᵢ=max(m*, sᵢ).

The process 300 computes the first partial attention component, the second partial attention component, the first attention component and the second attention component based, in part, on the current normalization scaler and the prior normalization scaler (304).

For example, the process 300 computes, for the current iteration count, the partial first attention component for the token by exponentiating the dot product of the query vector for the token and the key vector for the token adjusted by current normalization scaler, i.e., e^{s}^{ᵢ}^{-m}^{ᵢ}. To obtain the first attention component for the current iteration, the process 300 then sums the partial first attention component for the current iteration count with a product of the first attention component for the prior iteration count multiplied by an exponentiation of the difference of the prior normalization scaler and the current normalization scaler, i.e., s*e^{m*-m}^{ᵢ}+e^{s}^{ᵢ}^{-m}^{ᵢ}.

To obtain the second attention component for the current iteration, the process 300 sums the partial second attention component for the current iteration count, i.e., vᵢe^{s}^{ᵢ}^{-m}^{ᵢ}, with a product of the second attention component for the prior iteration count multiplied by the exponentiation of the difference of the prior normalization scaler and the current normalization scaler, i.e. v*e^{m*-m}^{ᵢ}+vᵢe^{s}^{ᵢ}^{-m}^{ᵢ}.

Finally, after processing all keys and values, the system then divides v* by s*. i.e., v*/s* to obtain the attention for the token.

FIG. 4 is a flow diagram of an example process 400 for implementing the system of FIG. 1 to facilitate parallel processing. Parallelism of current hardware, such as TPUs and GPUs, can be exploited by splitting a computation into chucks of constant size. While such splitting may require additional memory, the size of the chunks can be selected to balance between computational efficiency and memory requirements.

The process 400 splits queries into chunks of constant size (402). The splitting of the queries into chunks of constant size results in a linear number of iterations. The chunk size may be chosen based on properties of the hardware being used, such as the memory available to each thread of the parallel processing.

The process 400 processes keys and values in each chunk (404). The chunks are processed sequentially and each chunk is summarized independently of each other chunk. For example, in an implementation of chunk size of \sqrt{n} for the keys and values, the system 200 obtains \sqrt{n} summaries, resulting in O(\sqrt{n}) memory complexity.

The process 400 rescales computed values (406). The rescaling can be done in accordance with the process of FIG. 3, as described above. Then the process 400 computes attention by dividing second attention component by the first attention component (408).

While a constant chunk size for the queries and a chunk size of \sqrt{n} for the keys and values is optimal for memory consumption, the runtime is also affected by the choice of chunk size in practice. Runtime is also affected by the choice of hardware. According, this trade-off is to be considered by the designer.

During the forward pass, the process 400 of FIG. 4, in some implementations, utilizes checkpointing to save memory. The process 400 summarizes parts of the attention matrix sequentially, which allows the process 400 to “forget” the parts of the attention matrix it has previously summarized. In particular, checkpointing is applied to summarize the individual chunks. The intermediate results can thus be release from memory during the forward pass and recomputed during backpropagation, e.g., e.g., by running forward from the checkpointed results. While checkpointing will impact compute speed because some values must be recomputed during backpropagation, checkpointing reduces memory requirements.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine: in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method of computing attention for one or more tokens, the method comprising:
receiving a set of n tokens arranged in respective ordinal positions;
for at least one of the tokens:
iteratively computing a first attention component for the token and a second attention component for the token based on respective ordinal positions of the n tokens, and for each iteration:
computing, for a current iteration count, a partial first attention component for the token that is based on a dot product of a query vector for the token and a key vector for a token at an ordinal position in the set of tokens that correspond to the current iteration count;
computing, for the current iteration count, a partial second attention component for the token that is a product of the partial first component computed for the current iteration count and a value vector for the token at the ordinal position in the set of tokens that corresponds to the current iteration count;
when a partial first attention component has been computed for the token for a prior iteration count for the token, summing the partial first attention component for the current iteration count with the first attention component from the prior iteration count to obtain the first attention component for the token;
when a partial second attention component has been computed for the token for a prior iteration count for the token, summing the partial second attention component for the current iteration count with the second attention component from the prior iteration count to obtain the second attention component for the token; and
computing the partial first attention component, the partial second attention components, the first attention component and the second attention component based, in part, on a current normalization scaler for the iteration and a prior normalization scaler for a prior iteration;
after iteratively computing the first attention component and the second attention component for the token, computing attention for the token by dividing the second attention component by the first attention component.

2. The computer-implemented method of claim 1, wherein computing the partial first attention component for the token further comprises exponentiating the dot product of the query vector for the token and the key vector for the token at the ordinal position in the set of tokens that corresponds to the current iteration count.

3. The computer-implemented method of claim 2, wherein the method comprises, for each iteration:
determining, based on the current iteration and prior normalization scaler, the current normalization scalar.

4. The computer-implemented method of claim 3, wherein for each iteration:
computing, for the current iteration count, the partial first attention component for the token comprises exponentiating the dot product of the query vector for the token and the key vector for the token adjusted by current normalization scaler;
summing the partial first attention component for the current iteration count with the first attention component from the prior iteration count to obtain the first attention component for the token comprises summing the partial first attention component for the current iteration count with a product of the first attention component for the prior iteration count multiplied by an exponentiation of the difference of the prior normalization scaler and the current normalization scaler; and
summing the partial second attention component for the current iteration count with the second attention component from the prior iteration count to obtain the second attention component for the token comprises summing the partial second attention component for the current iteration count with a product of the second attention component for the prior iteration count multiplied by the exponentiation of the difference of the prior normalization scaler and the current normalization scaler.

5. The computer-implemented method of claim 1, wherein each token corresponds to a portion of a sentence.

6. The computer-implemented method of claim 1, wherein each token is generated using an embedding algorithm.

7. The computer-implemented method of claim 1, wherein the query vector is a vector based on a query matrix of a transformer.

8. The computer-implemented method of claim 7, wherein the value vector is a vector based on a value matrix of a transformer.

9. The computer-implemented method claim 8, wherein the key vector is a vector based on a key matrix of a transformer.

10. The computer-implemented method of claim 1, wherein summing the partial first attention component for the current iteration count with the first attention component from the prior iteration count to obtain the first attention component for the token comprises storing the first attention component for the token in a same memory location for each iteration.

11. The computer-implemented method of claim 1, wherein summing the partial second attention component for the current iteration count with the second attention component from the prior iteration count to obtain the second attention component for the token comprises storing the second attention component for the token in a same memory location for each iteration.

12. The computer-implemented method of claim 1, further comprising:
for each token of the n tokens, in sequence:
iteratively computing the first attention component for the token and the second attention component for the token based on respective ordinal positions of the n tokens;
after iteratively computing the first attention component and the second attention component for the token, computing attention for the token by dividing the second attention component by the first attention component.

13. A system comprising:
one or more computers; and
one or more storage devices communicatively coupled to the one or more computers, wherein the one or more storage devices store instructions that, when executed by the one or more computers, cause the one or more computers to perform operations of the respective method of claim 1.

14. One or more non-transitory computer storage media storing instructions that when executed by one or more computers cause the one or more computers to perform operations of the respective method of claim 1.
